(19) United States
(12) Patent Application Publication
(10) Pub. No.: US 2026/0134395 A1
(43) Pub. Date: May 14, 2026

(54) Project-Focused AI Collaboration Environment with Integrated Real-Time AI Model Usage

(71) Applicant: Trilogy Enterprises, Inc., Austin, TX (US)

(72) Inventors: Arthur Michel, Brooklyn, NY (US); Benji Bizzell, Asheville, NC (US); Neeraj Gupta, Austin, TX (US)

(73) Assignee: Trilogy Enterprises, Inc., Austin, TX (US)

(21) Appl. No.: 19/390,303

(22) Filed: Nov. 14, 2025

Related U.S. Application Data
(60) Provisional application No. 63/720,178, filed on Nov. 14, 2024.
(60) Provisional application No. 63/720,179, filed on Nov. 14, 2024.

(51) Int. Cl. G06Q 10/10; G06F 16/3329; G06F 40/30

(52) U.S. Cl. CPC G06Q 10/103; G06F 16/33295; G06F 40/30

(57) ABSTRACT

A collaborative project workspace system and process facilitates real-time interaction between multiple users and an artificial intelligence (AI) engine within a shared project workspace. The collaborative project workspace system and process maintain a project database that stores users queries, documents, communications, responses, and user interactions. Through a user interface, the users can submit queries and documents, which are processed by an AI control system and transferred to an embedding module. The embedding module transforms inputs into vector representations, which are then stored in a vector database. Using this vectorized data along with contextual information from the vector database, the collaborative project workspace system and process generate responses through AI engines that combine both large and small language models.

### CROSS-REFERENCE TO RELATED APPLICATION(S)

This application claims the benefit under 35 U.S.C. § 119(e) and 37 C.F.R. § 1.78 of U.S. Provisional Application Nos. 63/720,178 and 63/720,179, which are incorporated by reference in their entireties.

### FIELD OF THE INVENTION

The present invention generally relates to the field of electronics, and more specifically to collaborative project workspace systems and processes that facilitate real-time interactions between multiple users and an artificial intelligence (AI) engine within shared project workspaces.

### DESCRIPTION OF THE RELATED ART

Project management tools have evolved significantly in the digital era, transforming from basic spreadsheets and whiteboards to sophisticated software solutions powered by cutting-edge technologies. As organizations face increasingly complex projects and distributed users, the demand for more efficient and intelligent project management solutions has sparked innovation across distinct categories. The intersection of traditional methodologies and emerging technologies has created a spectrum of tools.

Traditional project management tools oversee projects and foster the user collaboration, however, operate within notable constraints. The traditional project management tools allow the users to track deadlines, assign responsibilities, and manage workflows. The users used to manually update task statuses, share files, and communicate through the traditional project management tools. The traditional project management tools serve their basic purpose of project organization but require the users to handle all decision-making and analytical processes themselves, creating a more labor-intensive management experience.

Moreover, artificial intelligence (AI) tools are utilized simultaneously with the traditional project management tools. However, the AI tool forces the users to constantly switch between different applications and interfaces, disrupting the natural workflow. The users need to juggle between their project management tool and the AI tool, which creates unnecessary switching and reduces productivity. The users waste valuable time copying and pasting between tools, replicating work, and trying to maintain consistency across disconnected platforms. The AI tool is unable to directly access or update project data in real-time, limiting the effectiveness in supporting day-to-day project activities.

The hybrid tool having AI plugins are used that combine traditional project management features with artificial intelligence capabilities. The hybrid tools attempt to merge the traditional project management tools with the AI-powered assistance, but the hybrid tools face significant limitations. Typically, project managers and the users integrate the hybrid tools into their workflows to automate basic projects and get the AI-assisted suggestions, yet the AI integration often remains nonproductive. The AI integration prevents users from leveraging the full potential of AI within their project context, as the users cannot interact deeply or in real-time. The users end up switching between different features or platforms to accomplish tasks that ideally should work seamlessly together, which ultimately reduces workflow efficiency and productivity.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary collaborative project workspace system.

FIG. 2 depicts an exemplary collaborative project workspace process utilized by the collaborative project workspace system.

FIG. 3 depicts an output generation process, which is an embodiment of the collaborative project workspace process of FIG. 2.

FIG. 4 depicts the data structure representing interaction within the project workspace.

FIG. 5 depicts an exemplary project documentation process, which is an embodiment of the collaborative project workspace process of FIG. 2.

FIGS. 6-8 are exemplary user interface depicting the interaction of the plurality of user with the collaborative project workspace system.

FIG. 9 depicts an exemplary network environment in which the system of FIG. 1 and the process of FIG. 2 may be practiced.

FIG. 10 depicts an exemplary computer system.

### DETAILED DESCRIPTION

A collaborative project workspace system and process facilitates real-time interaction between multiple users and an artificial intelligence (AI) engine within a shared project workspace. The collaborative project workspace system and process maintains a project database that stores queries, documents, communications, responses, and user interactions. Through a user interface, the plurality of users can submit queries and documents, which are processed by an AI control system and transferred to an embedding module. The embedding module transforms inputs into vector representations, which are then stored in a vector database. Using this vectorized data along with contextual information from the vector database, the collaborative project workspace system and process generate responses through AI engines that combine both large and small language models.

Some of the applications of the collaborative project workspace system and process are real-time AI-assisted decision making, document synchronization and management, seamless integration with external APIs, automated meeting summaries, custom AI workflows, interactive training sessions, project performance analytics, enhanced security monitoring, resource allocation optimization, client interaction, and feedback integration.

The collaborative project workspace system significantly advances project collaboration by seamlessly integrating AI engine capabilities directly into the workflow. Unlike traditional project management tools that force users to switch between multiple applications for AI analysis, document management, and team communication, the collaborative project workspace system unifies all these functions in a single platform. The collaborative project workspace system maintains context across conversations and documents, allowing AI models to leverage the full history of project interactions to provide more relevant and insightful responses. The collaborative project workspace system approach reduces cognitive load and improves productivity by keeping the users focused on their work rather than juggling multiple tools.

The collaborative project workspace system uses one or more user queries, one or more project documents, real-time communication, responses, and user interaction. The collaborative project workspace system automatically indexes one or more user queries, project documents, real-time communication, responses, and user interaction and makes them available for future queries, creating a continuously evolving project intelligence that grows more valuable over time. The users benefit from insights generated from the collective knowledge of all previous interactions rather than starting fresh with each new conversation.

The system and method set forth herein address technical issues with generating the desired outputs described herein. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

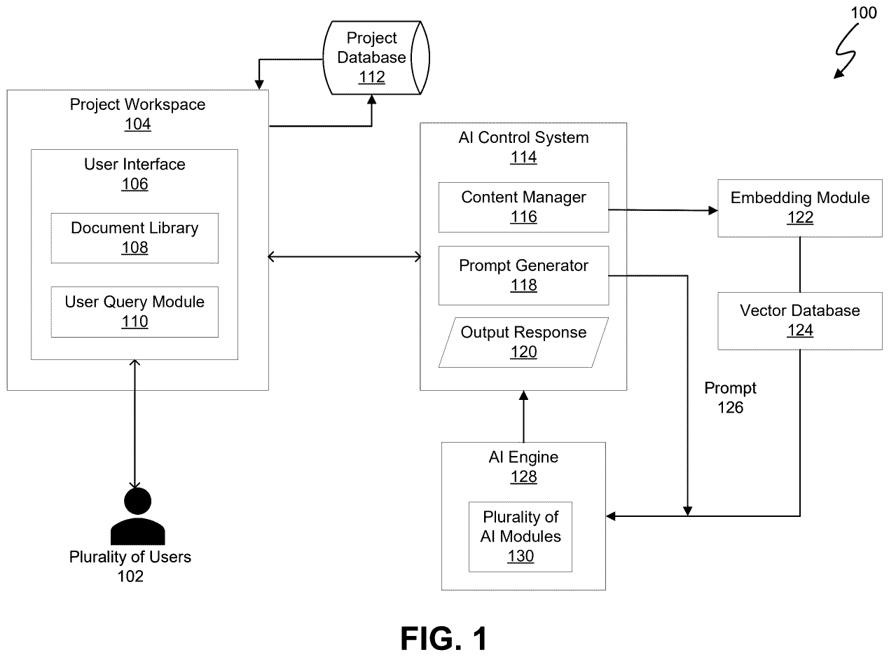

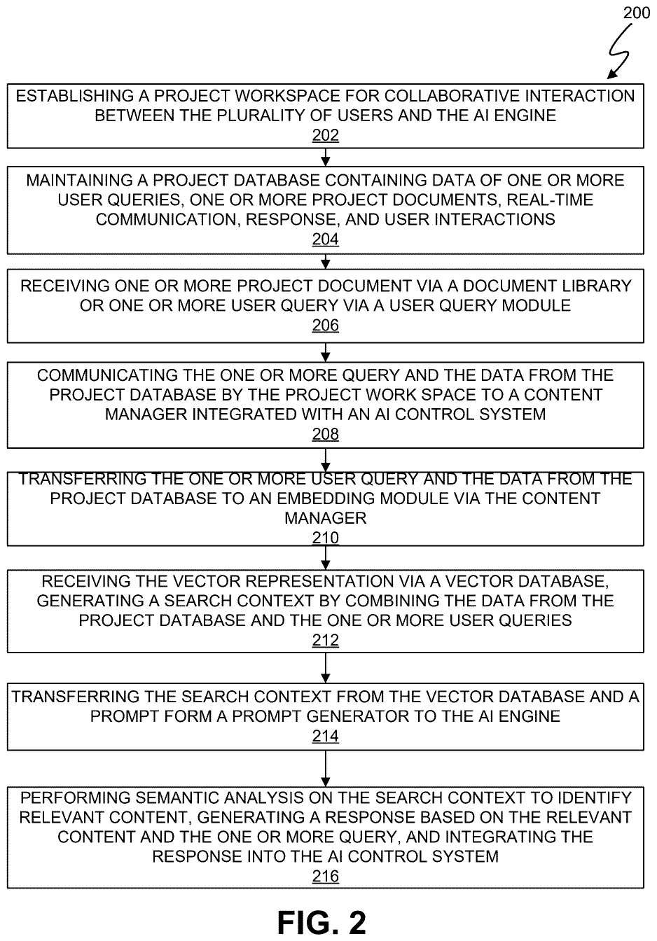

FIG. 1 depicts an exemplary collaborative project workspace system 100. FIG. 2 depicts an exemplary collaborative project workspace process 200, utilized by the collaborative project workspace system 100.

Referring to FIGS. 1 and 2, in operation 202, a collaborative project workspace system 100 establishes a project workspace 108 for collaborative interaction between the plurality of users 102 and an AI engine 128. The project workspace 104 establishes real-time communication channels.

The collaborative project workspace system 100 establishes the project workspace 104 by setting up a unified platform that enables real-time collaboration between the plurality of the users 102 and the AI engine 128. The project workspace 104 includes user interface 106, which is used by the plurality of the users 102 for providing documents and queries. A document library 108 is integrated to the user interface 106 for collecting documents from the plurality of the users 102 and a user query module 110 is integrated to the user interface 102 for collecting the one or more user queries that the plurality of the users 102 is having.

The project workspace 104 is a dedicated environment designed for managing and organizing all the resources, tools, and activities related to a specific project. The project workspace 104 serves as a centralized hub where the plurality of users 102 can collaborate, track progress, share information, and access the necessary materials to complete the project effectively. The project workspace 104 uses a WebSocket connection to enable live updates and real-time interactions between the plurality of the users 102 or the interaction between the plurality of the users 102 with the AI engine 128. The WebSocket actively enables real-time data exchange, allowing both the project workspace 104 and an AI control system 114 to send messages to each other independently at any time. The protocol starts with an HTTP handshake before upgrading to a persistent WebSocket connection, actively removing the need for repeated HTTP requests. Once established, the WebSocket connection efficiently transmits data in both directions using small frame headers.

In at least one embodiment, the WebSocket server uses frameworks like Socket. IO or ws for Node.js and configures to listen on a specific port. Then the WebSocket creates WebSocket endpoints in the AI control system 114 to handle incoming connections and defines message event handlers. Then, implement the WebSocket client in the project workspace that connects to the AI control system 114 WebSocket server using the appropriate Web Socket URL (ws://or wss://protocol). Set up event listeners to process incoming messages from the AI control system 114 and define methods to send control commands or data updates. Finally, implement error handling, reconnection logic, and message validation to ensure robust communication. The WebSocket server enables real-time bidirectional communication where the project workspace 104 can send the data to the AI control system 114, while the AI control system 114 can send back control commands or analysis results instantaneously or later.

In operation 204, a project database 112 stores data of the one or more user queries, one or more project documents, real-time communication, output response 120, and user interactions. The project database 112 receives the data from the project workspace 104. The project database 112 is a structured repository that stores all the data and information related to a specific project or a collection of projects received by the project workspace 104. The project database 112 includes details such as project goals, timelines, tasks, resources, budgets, team roles, deliverables, and progress metrics. The project database 112 ensure easy access, organization, and analysis of project data.

The project database 112 collects all the data received by the project workspace 104. The collaborative project workspace system 100 implements a centralized data collection mechanism where all interactions and content within the project workspace 102 are automatically captured and stored. The project database 112 continuously monitors and records multiple types of data: user queries, project documents, real-time communication, response, and user interaction. When the users 102 engage in conversations, the project database 112 collects the data. The project database 112 comprises a cloud-based storage system. The one or more user queries are the questions submitted by the plurality of the users 102 in the user query module 110. The project document includes the document submitted by the plurality of the users 102 in the document library 108 related to the project in which the plurality of the users 102 is working. In at least one embodiment, the project database 112 contains complete data of the project in which the plurality of the users 102 are working. The real-time communication is the data of the communication within the plurality of users 102 or the communication between the AI engine 128 and the plurality of users 102. The response is defined as the response received by the AI engine 128. The plurality of the users 102 interaction contains the data of the chat history within the plurality of users 102 or the chat history between the AI engine 128 and the plurality of users 102.

In at least one embodiment, the collaborative project workspace system 100 uses one of the cloud-based storage systems from Amazon Web Services, Microsoft Azure, Google Cloud Platform, Oracle Cloud Infrastructure, IBM Cloud, and Alibaba Cloud. The Amazon Web Services owned by Amazon, has headquarters in Seattle, Washington, United States. Amazon web services provide cloud computing platforms and APIs to individuals, companies, and governments on a pay-as-you-go basis. The Microsoft Azure owned by Microsoft Corporation, having headquarters in Redmond, Washington, United States enables businesses to build, deploy, and manage applications and services through Microsoft's global network of datacenters. The Google Cloud Platform owned by Alphabet Inc having headquarters in Mountain View, California. The Google Cloud Platform as a suite of cloud computing services, providing infrastructure, platform, and serverless computing capabilities alongside machine learning, data analytics, and API services. The Oracle Cloud Infrastructure owned by Oracle Corporation operates as an enterprise cloud computing platform, providing integrated services for compute, storage, networking, databases, and cloud-native development. The IBM Cloud owned by International Business Machines Corporation (IBM) as an integrated cloud computing platform, providing infrastructure, platform services, and software solutions for enterprise clients worldwide. The Alibaba Cloud is owned by Alibaba Group Holding Limited.

In operation 206, the document library 108 receives one or more project documents, or user query module 110 receives one or more user queries. The document library 108 and the user query module 110 are integrated within the user interface 106 of the project workspace 104.

The collaborative project workspace system 100 receives input through two primary channels integrated within the user interface 106 of the project workspace 108. The plurality of the users 102 can upload different project documents when the plurality of the users 102 wanted reference from the project document through document library 108. The document library 108 accepts various document formats for connected storage solutions such as Google Drive, automatically ingesting them into the project workspace. Simultaneously, the plurality of the users 102 can submit the one or more user queries through the user query module 110 integrated into the user interface 106.

The one or more user queries can be a request for information initiated by the plurality of user 102, where the query can be questions, commands, or requests for assistance. When the plurality of the users 102 submits the one or more user queries, the one or more user queries triggers a specific sequence of operations. In at least one embodiment, the one or more user queries carries intent, context, and parameters that guide how the collaborative project workspace system 100 should respond. For example, the user query might ask the AI engine 128 to analyze a document, generate insights, or perform specific tasks based on the project documents. The one or more user queries can take various forms, such as request document analysis, seek collaborative input, or ask for the AI engine 128 insights.

The project documents include content files within the collaborative project workspace system 100. The project document also includes different information, such as technical specifications, meeting notes, code files, research papers, design documents, project plans, presentations, reports, and other digital assets. Moreover, each of the project documents has a unique document ID that tracks the lifecycle.

The one or more project document and the one or more user queries received by the document library 108 and the user query module 110 respectively and are stored in the project database 112 such as Amazon Web Services, Microsoft Azure, Google Cloud Platform, Oracle Cloud Infrastructure, IBM Cloud, Alibaba Cloud and so forth.

When the one or more project documents or the one or more user queries are received, the collaborative project workspace system 100 immediately begins processing project documents or the one or more user queries through the AI control system 112. For the project documents, the AI control system 114 routes them through the content manager 114 to prepare them for AI engine 128. For queries, the AI control system 114 directs the prompt generator 118 and a content manager 114 to formulate appropriate AI engine 128 responses. The collaborative project workspace system 100 performs all reception and routing operations in real-time, ensuring immediate response to the one or more user queries. As the project documents or the one or more user queries enter the project workspace 104, immediately begin flowing through the appropriate processing pipelines.

The user interface 106 integrates an option of selecting a plurality of AI modules 130. The AI engine 128 can be selected by the plurality of the users 102 according to different work. The collaborative project workspace system 100 provides the user interface 104, where the plurality of users 102 can actively choose from plurality of AI modules 130, including Claude, GPT, Llama, and other language models based on their specific project needs.

In at least one embodiment, the plurality of users 102 access the selection through a dropdown menu or toggle in the chat interface, allowing the plurality of users 102 to switch between different AI engines 128 while working. The collaborative project workspace system 100 maintains connections to various AI engine 128 providers and allows the plurality of users 102 to select the most appropriate AI engine 128 for their current project. For example, choosing GPT-4 for complex analysis, Claude for nuanced writing, or Llama for simpler queries.

In at least one embodiment, the plurality of users 102 receive responses through the AI leaderboard feature, which compares the plurality of AI module 130 with the output responses 120. The collaborative project workspace system 100 automatically runs the one or more user queries through the plurality of AI modules 130 simultaneously, displaying comparative results from each of the AI modules 130. This helps the plurality of users 102 to evaluate which AI modules amongst the plurality of AI module 130 perform best for particular types of projects. The collaborative project workspace system 100 also enables the plurality of AI module 130 to switch during conversations in real-time, allowing the plurality of users 102 to seamlessly transition between the plurality of AI modules 130 as requirements change. For example, the plurality of users might use Perplexity for internet searches, then switch to Claude for document analysis, all within the same project workspace 104. The user interface 106 actively preserves the context and history of conversations regardless of which the plurality of AI modules 130 is selected, ensuring continuity in the workflow even when switching between the plurality of AI modules 130.

In at least one embodiment, the user interface 106 includes a private chat interface for the individual user interaction with the AI engine 128, a shared chat interface for read-only access to AI engine 128 interactions, and a multi-user chat interface enabling simultaneous interaction between the plurality of the users 102 and the AI engine 128.

The collaborative project workspace system 100 implements three specialized chat interfaces inside the user interface 106 to accommodate different collaboration needs. In the private chat interface, the user from the plurality of users 102 engages directly with the AI engine 128 without other users 102, this creates a personal workspace for the plurality of users 102. The shared chat interface serves as a viewing platform where the plurality of users 102 can observe and learn from others interactions with the AI engine 128 without actively participating. The multi-user chat interface enables dynamic group collaboration where the plurality of users 102 actively engage with the AI engine 128 simultaneously. When the plurality of users 102 enter the space, the user interface 106 broadcasts all messages and the AI engine 128 provides responses in real-time via WebSocket connections, allowing the entire users 102 to participate in the conversation.

In operation 208, one or more user queries and the data from the project database 112 are communicated by the project workspace 104 to a content manager 116 integrated with the AI control system 114. The project workspace 104 sends the one or more user queries and the relevant data to the content manager 116 within the AI control system 114. When the plurality of users 102 submits the one or more user queries through the user interface 106, the AI control system 114 immediately routes the one or more user queries along with relevant data pulled from the project database 112 to the content manager 116. The content manager 116 serves as the central coordination point, receiving the one or more user queries and the data from the project database 112 for the AI engine 128 processing.

The data from the project database 112 includes one or more user queries, one or more project documents, real-time communication, output response 120, and user interaction. The content manager 116 actively processes the combined data, preparing the data for the AI engine 128, by organizing the one or more user queries and its data into a structured format that the AI engine 128 can effectively process. The collaborative project workspace system 100 maintains real-time connections between the project workspace 104 and the AI control system 114 through established communication channels, ensuring immediate transmission of the one or more user queries and the data. The communication enables the content manager 116 to gather all necessary information from both the one or more user queries and one or more project documents, real-time communication, output response 120, and user interaction from the AI engine 128 processing.

The project document includes the document submitted by the plurality of users 102 in the document library 108 related to the project in which the plurality of users 102 are working. In at least one embodiment the project document contains complete data on the project in which the plurality of users 102 are working. The real-time communication is the data of the communication within the plurality of users 102 or the communication between the AI engine 128 and the plurality of users 102. The output response 120 is defined as the response received by the AI engine 128. The user interaction contains the chat history within the plurality of users 102 or the chat history between the AI engine 128 and the plurality of users 102.

In operation 210, the content manager transfers the one or more user queries and the data from the project database 112 to an embedding module 122. The embedding module 122 transforms discrete input into a vector representation.

The content manager 116 transfers the one or more user queries and data which includes the data of one or more user queries, one or more project documents, real-time communication, output response 120, and user interactions, to the embedding module 120 for the vector transformation. When the embedding module 122 receives input, the embedding module 120 processes both the query and the data from the project database 112 through its transformation pipeline. The embedding module 122 first pre-processes the discrete inputs, breaking down documents and the one or more user queries into appropriate chunks for vectorization. The embedding module 122 then converts these chunks into vector representations using specialized embedding algorithms and neural networks.

The embedding module 122 functions as a sophisticated text-to-vector converter that captures the semantic meaning of input from the content manager 116. When the input from the content manager 116 enters the embedding module 122, it first tokenizes the content, breaking down sentences into individual words or sub-words. For example, if the input is “machine learning applications,” the embedding module 122 splits it into “machine,” “learning,” and “applications.”

In at least one embodiment, the embedding module 122 converts the tokens into dense numerical vectors using trained neural networks. The numerical vectors typically contain hundreds or thousands of dimensions and each dimension represents some learned semantic feature. For example, a 768-dimensional vector might capture aspects like “technical terminology,” “action words,” or “abstract concepts.” The embedding module 122 maps similar words close together in this high-dimensional space words like “car” and “automobile” would have similar vector representations.

For example, when processing the user query about “sales performance in Q2,” the embedding module 122 might generate a vector like [0.123, −0.456, 0.789, . . . ] with hundreds more numbers. The embedding module 122 maintains consistency in vector outputs by using the trained model and dimension for all conversions. This ensures that when the plurality of users 102 later wants to compare the user query vector with the project database 112 content vectors, the plurality of users 102 can use mathematical operations like cosine similarity to find relevant matches. For example, a document about “Q2 revenue analysis” would produce a vector mathematically similar to our “sales performance” query vector.

In at least one embodiment, the embedding module 122 employs pre-trained language models like BERT or similar architectures that have learned rich semantic representations from massive text corpora. The embedding module 122 fine-tunes these representations for specific domains and data types. For instance, if the project database 112 contains technical documentation, the embeddings will adapt to capture technical terminology and relationships more precisely.

In at least one embodiment, the embedding module 122 employs several methods to convert tokens into dense numerical vectors, such as Word2Vec leads the pack, using either Continuous Bag of Words (CBOW) or Skip-gram architectures to learn vector representations by predicting words from their context or vice versa. GloVe takes a different approach, building vectors by analyzing global word co-occurrence statistics in the corpus. FastText extends the embedding capability by breaking words into character N-grams, allowing the FastText to handle out-of-vocabulary words and morphologically rich languages. Doc2Vec expands on Word2Vec by adding document context to generate vectors for entire documents alongside individual words. The neural network learns these representations through backpropagation during training, adjusting the vectors to minimize the difference between predicted and actual word distributions in the training corpus. Each method produces vectors typically ranging from 100 to 1024 dimensions, where each dimension represents a learned feature of the word's meaning and usage patterns. In at least one embodiment, the embedding module 122 employs newer transformer-based models such as BERT, ROBERTa, or GPT that create dynamic, context-aware embeddings through their deep neural architectures.

In operation 212, a vector database 124 receives the vector representation, generating a search context by combining the data from the project database 112 and the one or more user query. Note, in other embodiments, the vector database 124 can be substituted with another type of database that supports vectors such as a graph, traditional SQL/NoSQL with embedded vector indexes, and Elasticsearch databases. The vector database 124 stores and manages high-dimensional vectors that represent data points, enabling efficient similarity searches across large datasets. These vectors capture various data types, such as text, images, audio, or any other format that can be converted into numerical representations.

When the vector database 124 receives vector representations from the embedding module 122, the vector database 124 immediately begins the context generation process. The vector database 124 executes similarity searches using the query vectors against stored project document vectors in a Pinecone vector database, typically retrieving the most semantically relevant chunks. For each query vector, the vector database 124 performs chunked retrieval operations.

Typically, Pinecone is a cloud-based vector database service that helps build and scale applications powered by machine learning and artificial intelligence. Pinecone specializes in vector similarity search, enabling efficient storage and retrieval of high-dimensional vector embeddings. Pinecone is used to handle complex operations like semantic search, recommendation systems, and image similarity matching across massive datasets. Pinecone automatically manages infrastructure scaling, data replication, and performance optimization, allowing the plurality of users 102 to focus on building their applications rather than managing database operations. Pinecone supports real-time updates, handles thousands of queries per second, and integrates seamlessly with popular machine learning frameworks like TensorFlow and PyTorch.

The vector database 124 ranks and prioritizes this combined information based on semantic similarity and relevance to the user query. When building the search context, the system considers both the immediate query vector and the broader project context, creating a comprehensive knowledge framework for the AI engine 128 to process. Through this vector-based retrieval and combination process, the collaborative project workspace system 100 generates a rich, contextually aware search environment that captures the intent of the one or more user queries and the project database 112.

In at least one embodiment, the vector database 124 employs specialized indexing techniques to organize these vectors for fast retrieval. The most common approach uses approximate nearest algorithms such as hierarchical navigable small world or inverted file index. The hierarchical navigable small world, or inverted file index, creates efficient search structures that can quickly find similar vectors without examining every single entry in the vector database 124.

In operation 214, the search context from the vector database 124 and a prompt 126 from a prompt generator 118 is transferred to plurality of AI module 130. The vector database 124 sends the search context to the AI engine 128 while simultaneously, the prompt generator 118 constructs and delivers the prompt 126. The AI engine 128 receives the prompts 126 and the search context for the response 120 generation. For each query, the prompt generator 118 creates a structured prompt 126 based on the type of request and intended outcome, incorporating project-specific requirements and the user 102 context. The structure of the prompt 126 is designed by the prompt engineer, and modification in the prompt 126 is done by the prompt generator 118 according to different scenarios. In at least one embodiment, the transfer to the AI engine 128 is done through an application programming interface (“API”). Prompt 126 represents multiple prompts used to guide and constrain the AI engine 128 to support the collaborative project workspace system 100 and process 200. Appendix A sets forth exemplary prompts 126.

The API enables software programs to communicate with each other through a set of defined rules and protocols. The APIs are used to access specific features or data from other applications without needing to understand their internal workings. The APIs serve as bridges that allow different systems or modules to exchange information and functionality seamlessly.

In operation 216, the AI engine 128 performs semantic analysis on the search context to identify relevant content and generates output response 120 based on the relevant content and the one or more user queries. The output response 120 is integrated into the AI control system 114.

The AI engine 128 executes a multi-stage process to handle the search context and the one or more user queries. First, the AI engine 128 actively performs semantic analysis on the received search context using the plurality of AI module 130. The plurality of AI module 130 evaluates the semantic relationships between different pieces of content, comparing vector similarities to identify the relevant content for the query. During the analysis, the plurality of AI module 130 ranks and filters the content based on semantic relevance, ensuring that only the relevant content influences the output response 120.

Then, the plurality of AI module 130 generates the output response 120. The plurality of AI module 130 combines the semantically analyzed content with the one or more user queries and the prompt 126 instructions received from the prompt generator 118. When generating the output response 120, the AI engine 128 uses the plurality of AI models 130 such as Claude, Generative Pre-trained Transformer (GPT), or Llama for generating the output response 120.

Finally, the AI module 130 integrates the output response 120 into the AI control system 114. The output response 120 receives and processes the plurality of AI module 130 generated content, preparing the content for delivery back to the plurality of users 102. During integration, the collaborative project workspace system 100 stores the output response 120 in the project database 112 for future reference. The collaborative project workspace system 100 maintains real-time synchronization of the output responses 120 across all relevant communication channels, such as in private chats, shared viewing interfaces, or multi-user collaborative sessions. Through the content manager 116, the collaborative project workspace system 100 ensures the output response 120 remains accessible and properly contextualized within the project workspace.

The plurality of AI modules 130 integrates large language models (LLMs) and small language models (SLMs) for the output response 120 generation.

The AI modules 130 combine and coordinate multiple types of AI language models to generate output response 120 within the collaborative project workspace system 100. Specifically, the plurality of AI modules 130 integrate both LLMs, such as GPT-4, Claude, and Llama, alongside smaller SLMs. This multi-model approach allows the collaborative project workspace system 100 to leverage different capabilities of the plurality of AI modules 130 depending on the specific needs of the one or more user queries or the project.

The LLMs are neural networks that process and generate text by recognizing patterns in vast amounts of training data. The LLMs train using billions or trillions of text examples from sources such as books, websites, and articles. The LLMs learn to predict what words should come next in any given sequence, developing a sophisticated understanding of language patterns, facts, and relationships. Examples for LLMs are GPT-4, Claude, and PaLM, which can engage in conversations, write code, analyze documents, answer questions, and assist with creative tasks.

The SLMs focus on specific domains, tasks, or industries rather than trying to handle all types of language. The SLMs are created by training them intensively on carefully selected data from their target domain. For example, legal language models train primarily on legal documents, case law, and statutes, allowing them to better understand and generate legal text. Medical language models consume medical literature, clinical notes, and healthcare documentation to develop expertise in medical terminology and concepts.

The SLMs achieve higher performance in their focused domains compared to general-purpose LLMs. A financial language model that trains on market reports, financial statements, and economic papers will better understand complex financial terminology and relationships. Similarly, scientific language models that focus on research papers and technical literature develop deeper capabilities in analyzing and discussing scientific concepts. CodeLlama and Amazon CodeWhisperer demonstrate this specialization in programming, as these models train specifically on code repositories and programming documentation to excel at code generation and understanding.

Creating the SLMs involves organizations first collecting high-quality domain-specific training data, often supplemented with relevant general language data. The SLMs then optimize the model architecture and training approach for their specific use case. Many specialized models start with a general-purpose model and use transfer learning to adapt it to their domain. For instance, Bio-BERT builds on BERT's general language understanding but fine-tunes biomedical texts to better handle medical terminology and concepts. Companies also implement domain-specific evaluations and safety measures to ensure the model performs reliably within its intended scope.

The AI control system 114 integrates the output response 120 received from the AI engine 128 to the user interface 106 configured to display to the plurality of users 102. The output response 120 is delivered to the user interface 106 in real-time.

In at least one embodiment, the AI control system 114 processes the output response 120 from the AI engine 128 and integrates them into the user interface 106 through a structured pipeline. The AI control system 114 formats the output response 120 with proper styling, adds any necessary visual elements or formatting, and ensures consistent display across the different user interfaces 106 and screen sizes. The AI control system 114 broadcasts the output responses 120 to all of the plurality of users 102 in real-time, maintaining synchronized views across the collaborative project workspace system 100. When the multiple output responses 120 come from the plurality of AI models 130, the AI control system 114 aggregates and presents the output response 120 in an organized way that helps the plurality of users 102 compare and utilize the insights effectively.

In at least one embodiment, the user interface 106 displays the output responses 120 with preserving contextual links to source documents and related conversations, allowing the plurality of users 102 to trace the explanation and explore supporting information of the plurality of AI modules 130.

The AI engine 128 uses a training dataset for the tailored and relevant output responses 120 to the one or more user queries. The training dataset includes one or more user queries, one or more project documents, real-time communication, output response 120, and user interaction. The AI engine 128 uses a comprehensive training dataset to generate tailored and contextually relevant output response 120. The AI engine 128 learns from multiple data streams that flow through the AI engine 128, which include one or more user queries showing common question patterns and intent, project documents providing domain-specific knowledge and terminology, real-time communication capturing ongoing discussions and decision contexts, previous responses 120 establishing consistency in the AI engine 128 output, and the plurality of users 102 interactions revealing how the plurality of users 102 utilizes and responds to the AI engine 128. The AI engine 128 continuously processes and learns from the interactions, helping the AI engine 128 understand project-specific content, terminology, and the plurality of users 102 preferences. For example, when the user 102 frequently discusses certain technical concepts, the AI engine 128 learns to provide responses using familiar terms and references that resonate with the user 102 knowledge level. The dynamic learning process enables the AI engine 128 to maintain conversation context, reference the project documents, and provide output responses 120 that align with the plurality of users 102 collaborative patterns and project goals.

Pseudocode for an exemplary embodiment of the overall collaborative project workspace method 200:

function handleUserQuery(query, userContext) {
model = selectModelBasedOnContext(userContext);
response = model.processQuery(query);
updateProjectDocuments(response);
return response;
}
function syncDocuments( ) {
changes = checkForUpdatesInExternalSources( );
if (changes) {
updateLocalDocuments(changes);
notifyUsersOfChanges( );
}
}

In the above-mentioned pseudocode, a function handleUserQuery takes the one or more user queries and corresponding data as an input; the corresponding data includes the data of one or more user queries, project documents, real-time communication, output response 120, and user interactions. Then executes three key steps. First, a handleUserQuery function evaluates the one or more user queries to select the appropriate AI module from the plurality of AI modules 130 for processing the one or more user queries. Next, the handleUserQuery function processes the one or more user queries through the selected AI engine 128 to generate the output response. Finally, the handleUserQuery function updates any relevant project documents with the new information and returns the output response 120 to the plurality of users 102.

The second function syncDocuments manages document synchronization across the collaborative project workspace system 100. The syncDocuments function actively monitors external sources for any changes or updates. When the syncDocuments function detects changes, the syncDocuments function performs two actions: the syncDocuments function updates the local document copies to reflect the new information and sends notifications to the plurality of users 102 about the changes. The syncDocuments function ensures all the plurality of users 102 work with the most current information.

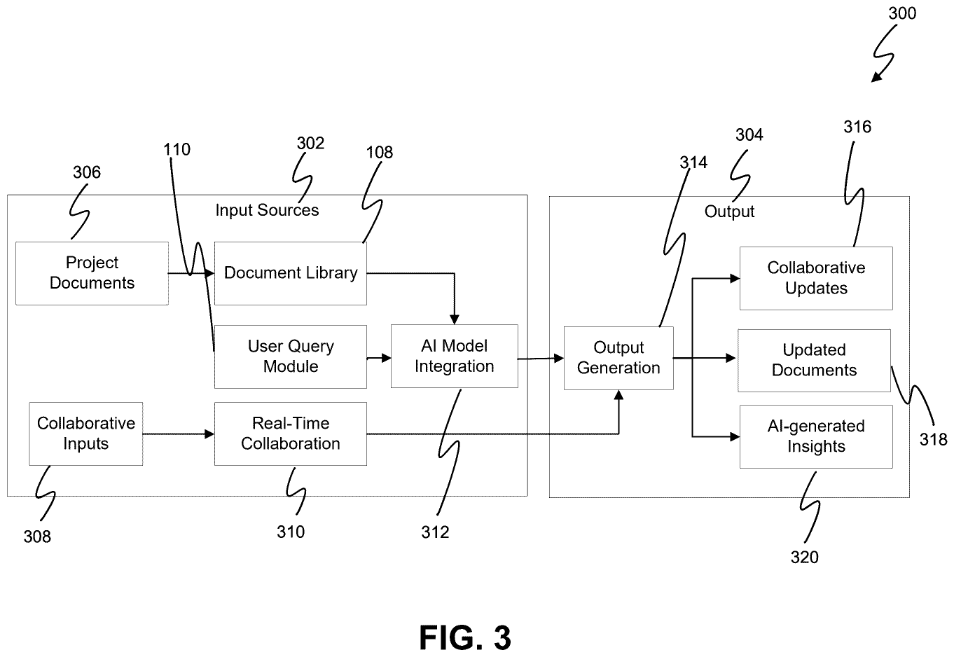

FIG. 3 depicts an output generation process 300, which is an embodiment of the collaborative project workspace process of FIG. 2. The functional block diagram 300 is divided into two parts: an input source 302 and an output 304. The input source 302 includes a project document 306, the document library 108, the user query module 110, a collaborative inputs 308, a real-time collaboration 310, and an AI model integration 312 of the AI engine 128. The output 304 includes an output generation 314, a collaborative update 316, an updated documents 318, and an AI-generated insights 320.

The project document 306 is transferred to the document library 108 and further transferred to AI model integration 312, which transfers the project document 306 to the output generation 314. The one or more user queries from the user query module 110 is transferred to AI model integration 312 and further transferred to output generation 314. The collaborative inputs 308 are transferred to real-time collaboration 310 and further transferred to the output generation 314.

The output generation 314 receives all the data from the input sources 302. The output generation 314 integrated within the output 304 generates output by transferring the data into the collaborative updates 316, the updated documents 318, and the AI-generated insights 320.

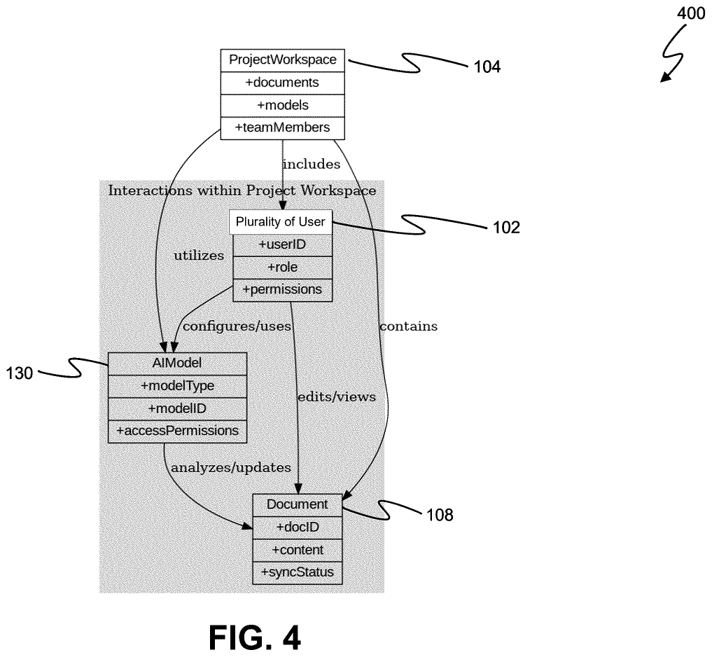

FIG. 4 depicts the data structure 400 representing interaction within the project workspace 104. The project workspace 104 serves as the central hub of the collaborative project workspace system 100. The project workspace 104 maintains three main components: documents, models, and team members, which is also referred to as a plurality of users 102. The AI model, which is referred to as the plurality of AI modules 130, contains essential information about each AI modules 130 in the collaborative project workspace system 100. The AI module 130 contains model types, assigns a unique model ID, and manages access permissions.

A document, also referred to as the document library 108, manages all project-related files and content. The document library 108 gives a unique document ID, stores the actual content, and maintains a sync status to track its current state in the collaborative project workspace system 100. The TeamMember component, also referred to as the plurality of users 102, represents the plurality of users 102 in the collaborative project workspace system 100. The plurality of users 102 has a unique user ID, an assigned role, and specific permissions that determine what they can do within the project workspace.

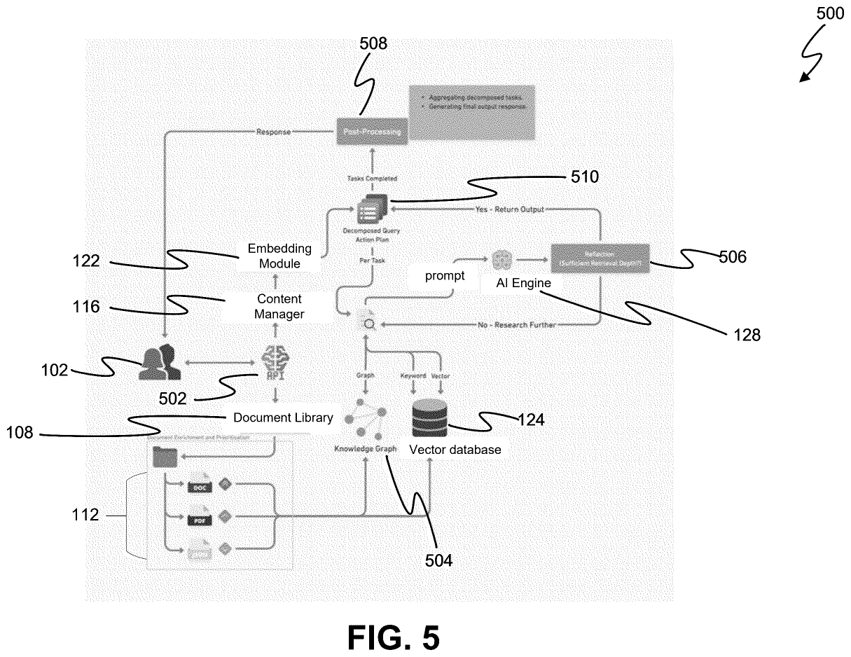

FIG. 5 depicts an exemplary project documentation process 500, which is an embodiment of the collaborative project workspace process 200 of FIG. 2.

The project documentation process 500 begins with the plurality of users 102 uploading project documents to the project database 112 through the document library 108. As shown, an API 502 is used to collect the project documents from a different system for uploading. The project documents include various formats, such as PDFs, Word files, emails, and so forth.

After uploading, the project documents are passed to the content manager 116. The content manager 116 integrated into the AI control system 114 transfers the project document to the embedding module 122, and transforms the project document content into numerical vectors, allowing the system to perform efficient searches, categorization, and ranking.

Following the embedding module 122, generate an action plan 510 that contains insights derived from the embedding module 122. The action plan 510, along with the data from the embedding module 122 is transferred to the vector database 124.

A knowledge graph 504 is used to generate the relationships and connections between various entities, the one or more user queries, or the project documents, thus aiding the plurality of users 102 in understanding the context and interconnections within the uploaded content.

The prompt generator 118 uses rules and guidelines from the prompt engineer 118 to create the prompt 126 and transfers the prompt 126 and the data from the vector database 124 to the plurality of AI modules 130 integrated within the AI engine 128. The AI engine 128 gives the output response 120 as the output.

The document processing system 500 then undergoes a reflection phase 506 and post-processing 508 to ensure that the response is coherent, accurate, and meets the user 102 expectations.

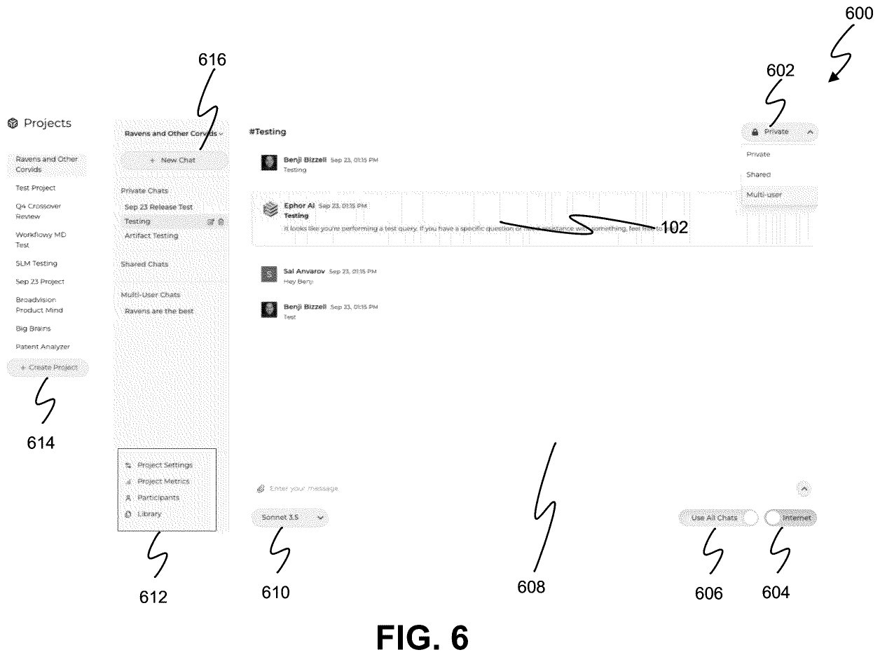

FIG. 6-8 are exemplary user interface 600, 700, and 800 depicting the interaction of the plurality of user 102 with the collaborative project workspace system 100. Referring to FIG. 6, as shown a drop-down list 602 gives the plurality of users 102 the option to select the mode of chat, such as whether private, shared, or multiuser. A toggle internet button 604 gives the option to the plurality of users 102 to choose whether to chat in the presence of the internet or whether to chat offline. A use all chat toggle button 606 gives the option to the plurality of users 102 to select all the chat history that needs to be included for answering the one or more user queries or a particular section of the chat that needs to be included for answering the one or more user queries. An AI module drop-down list 610 allows the plurality of user 102 to choose the different AI modules 130, such as GPT 4O, Cause 3.5, Lambda, etc. A search bar 608 allows the plurality of users 102 to give input to the collaborative project workspace system 100. A settings tool 612 that allows the plurality of users 102 to change the setting, for example, inviting plurality of users 102 into the chat. A create project 614 option gives the plurality of users 102 to create new projects. For example, SLM testing. A new chat 616 option provides the users 102 with creating new chat inside the create project 614 option. For example, inside a project such as SLM testing, the user 102 can create multiple new chats 616.

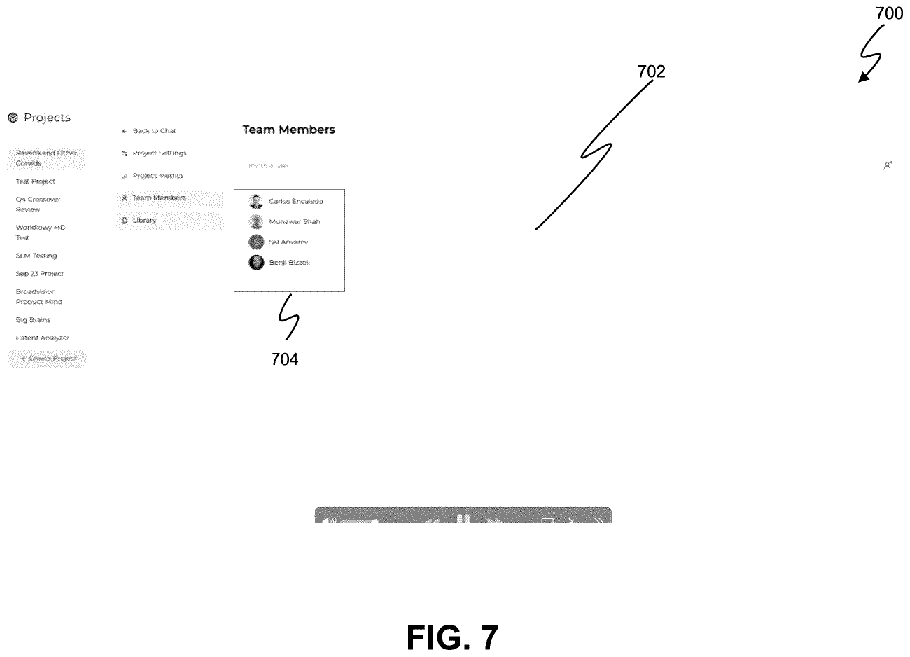

Referring to FIG. 7 depicts the user interface 700 for adding the plurality of users 102. As shown, the user interface 700 displays a search option 702, where the user 102 can search for the plurality of users 102 who need to be added to the chat. A user list 704 displays the plurality of users 102 shows the plurality of users 102 who are connected to the project.

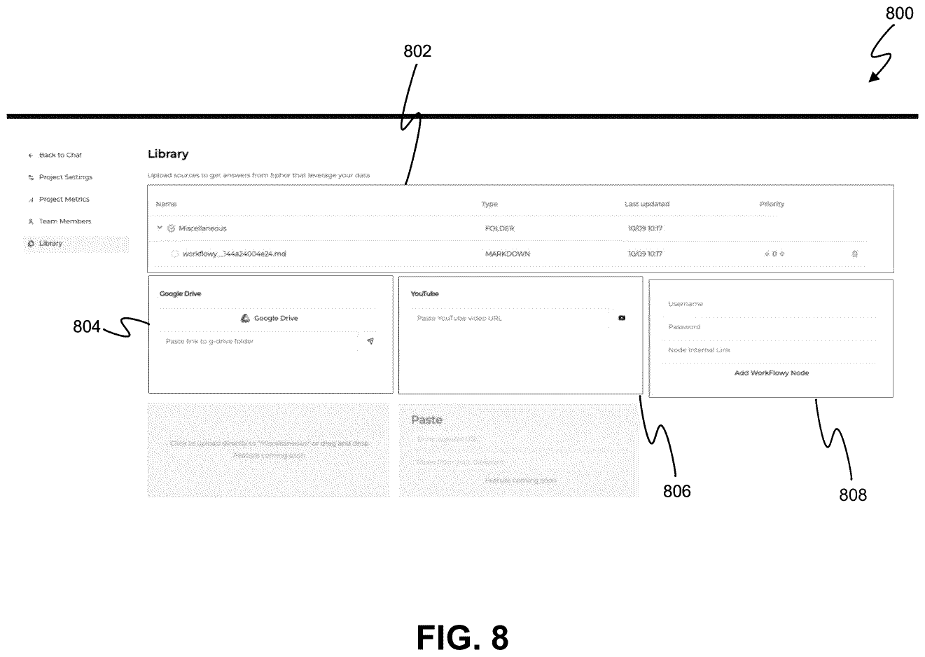

FIG. 8 depicts the user interface 800 for uploading and managing data sources. The user interface 800 for uploading and managing data sources includes a folder details 802 containing a file type, last update, and priority. A Google drive feature 804, the google drive feature 804 takes input as a Google Drive folder link. A YouTube link space 806 that takes YouTube video URLs as input. A user information section 808 which includes username, password, and Node Internal Link option.

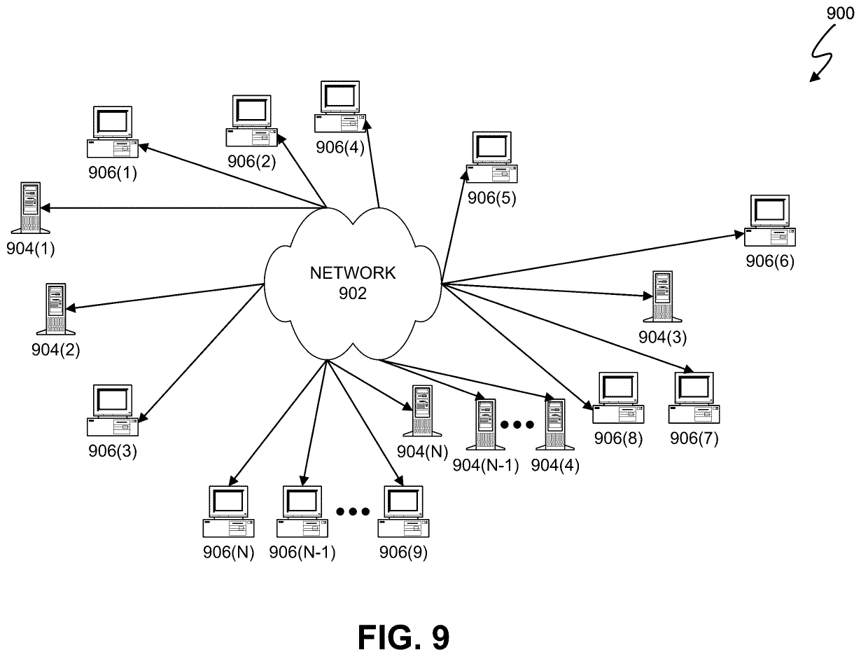

FIG. 9 is a block diagram illustrating a network environment in which a collaborative project workspace system 100 and process 200 may be practiced. Network 902 (e.g. a private wide area network (WAN) or the Internet) includes a number of networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example communications channels providing T1 or OC3 service. Client computer systems 906(1)-(N) typically access server computer systems 904(1)-(N) through a service provider, such as an internet service provider (“ISP”) by executing application specific software, commonly referred to as a browser, on one of client computer systems 906(1)-(N).

Client computer systems 906(1)-(N) and/or server computer systems 904(1)-(N) are specialized computer programmed to improve conventional computer systems to implement and utilize the collaborative project workspace system 100 and process 200. The type of computer system that can be specially programmed to implement and utilize the collaborative project workspace system 100 and process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the collaborative project workspace system 100 and process 200 can be implemented using code stored in a tangible, non-transient computer readable medium and executed by one or more processors. In at least one embodiment, the collaborative project workspace system 100 and process 200 can be implemented completely in hardware using, for example, logic circuits and other circuits including field programmable gate arrays.

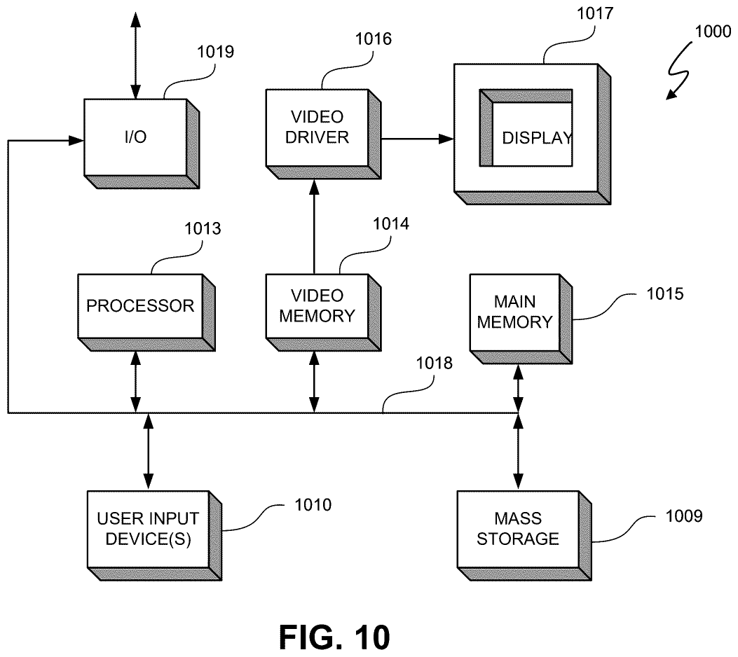

Embodiments of the collaborative project workspace system 100 and process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include both fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 1009, main memory 1015, video memory 1014 and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer systems via a telephone link or to the Internet via an ISP. I/O device(s) 1019 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1009, into main memory 1015 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the display 1017. Video amplifier 1016 is well known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The collaborative project workspace system 100 and process 200 may be implemented in any type of computer system or programming or processing environment. It is contemplated that the collaborative project workspace system 100 and process 200 might be run on a stand-alone computer system, such as the one described above. The collaborative project workspace system 100 and process 200 might also be run from a server computer systems system that can be accessed by a plurality of client computer systems interconnected over an intranet network. Finally, the collaborative project workspace system 100 and process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an artificial intelligence (AI) engine to interact with a plurality of users in a project workspace for creating a collaborative work environment comprising:
executing code using one or more processors of a computer system to cause the computer system to perform operations comprising:
establishing a project workspace for collaborative interaction between the plurality of users and the AI engine, wherein the project workspace establishes real-time communication channels;
maintaining a project database containing data of one or more user queries, one or more project documents, real-time communication, output response, and user interactions, wherein the project database receives the data from the project workspace;
receiving one or more project documents via a document library or one or more user queries via a user query module, wherein the document library and user query module are integrated with a user interface of the project workspace;
communicating the one or more user queries and the data from the project database by the project workspace to a content manager integrated with an AI control system;
transferring the one or more user queries and the data from the project database to an embedding module via the content manager, wherein the embedding module transforms discrete input into vector representation;
receiving the vector representation via a vector database, generating a search context by combining the data from the project database and the one or more user queries;
transferring the search context from the vector database and a prompt form a prompt generator to the AI engine to:
perform semantic analysis on the search context to identify relevant content,
generate a response based on the relevant content and the one or more user queries, and
integrate the response into the AI control system.

2. The method of claim 1, wherein a plurality of AI modules within the AI engine integrates large language models (LLMs) and small language models (SLMs) for response generation.

3. The method of claim 1, wherein the AI control system integrates the output response received from the AI engine to the user interface configured to display to the plurality of users.

4. The method of claim 1, wherein the project database collects all the data received by the project workspace.

5. The method of claim 1, wherein the user interface comprises:
a private chat interface for individual user interaction with the AI engine;
a shared chat interface for read-only access to the AI engine interactions; and
a multi-user chat interface enabling simultaneous interaction between the plurality of users and the AI engine.

6. The method of claim 1, wherein the project database comprises a cloud-based storage system configured to store the data of one or more user queries, project documents, real-time communication, output responses, and user interactions.

7. The method of claim 1, wherein the response generated for the one or more user queries includes generated insights, updated documents and project artifacts, and notifications and collaborative updates.

8. The method of claim 1, wherein the AI engine uses a training dataset for generating tailored and relevant output response to the one or more user queries, the training dataset includes: project management scenarios, collaborative interaction data, and industry-specific data.

9. The method of claim 1, wherein the user interface integrates an option of selecting the plurality of AI modules, the plurality of AI modules can be selected by the plurality of users according to different work.

10. The method of claim 1, wherein the response from the AI engine is integrated to the AI control system and delivered to the user interface in real-time.

11. A system for guiding an artificial intelligence (AI) engine to interact with a plurality of users in a project workspace for creating a collaborative work environment comprising:
one or more processors of a computer system;
memory, coupled to the one or more processors, that stores code and execution of the code by the one or more processors causes the computer system to perform operations comprising:
establishing a project workspace for collaborative interaction between the plurality of users and the AI engine, wherein the project workspace establishes real-time communication channels;
maintaining a project database containing data of one or more user queries, one or more project documents, real-time communication, output response, and user interactions, wherein the project database receives the data from the project workspace;
receiving one or more project documents via a document library or one or more user queries via a user query module, wherein the document library and user query module are integrated with a user interface of the project workspace;
communicating the one or more user queries and the data from the project database by the project workspace to a content manager integrated with an AI control system;
transferring the one or more user queries and the data from the project database to an embedding module via the content manager, wherein the embedding module transforms discrete input into vector representation;
receiving the vector representation via a vector database, generating a search context by combining the data from the project database and the one or more user queries;
transferring the search context from the vector database and a prompt form a prompt generator to the AI engine to:
perform semantic analysis on the search context to identify relevant content;
generate a response based on the relevant content and the one or more user queries, and
integrate the response into the AI control system.

12. The system of claim 11, wherein a plurality of AI modules within the AI engine integrates large language models (LLMs) and small language models (SLMs) for response generation.

13. The system of claim 11, wherein the AI control system integrates the output response received from the AI engine to the user interface configured to display to the plurality of users.

14. The system of claim 11, wherein the project database collects all the data received by the project workspace.

15. The system of claim 11, wherein the user interface comprises:
a private chat interface for individual user interaction with the AI engine;
a shared chat interface for read-only access to the AI engine interactions; and
a multi-user chat interface enabling simultaneous interaction between the plurality of users and the AI engine.

16. The system of claim 11, wherein the AI engine uses a training dataset for generating tailored and relevant output response to the one or more user queries, the training dataset includes: project management scenarios, collaborative interaction data, and industry-specific data.

17. The system of claim 11, wherein the output response generated for the one or more user queries includes generated insights, updated documents and project artifacts, and notifications and collaborative updates.

18. The system of claim 11, wherein the user interface integrates an option of selecting the plurality of AI modules, the plurality of AI modules can be selected by the plurality of users according to different work.

19. The system of claim 11, wherein the response from the AI engine is integrated to the AI control system and delivered to the user interface in real-time.
